(19) United States
(12) Patent Application Publication
(10) Pub. No.: US 2024/0128996 A1
(43) Pub. Date: Apr. 18, 2024

(54) REMOTE REPEATER DEVICE FOR MOBILE DEVICE DOCK AND METHODS OF MAKING AND USING

(71) Applicant: National Products, Inc., Seattle, WA (US)

(72) Inventors: Jeffrey D. Carnevali, Seattle, WA (US); Scott Anderson, Seattle, WA (US); Stefan Michael Gottschalk, Seattle, WA (US)

(21) Appl. No.: 17/965,372

(22) Filed: Oct. 13, 2022

(51) Int. Cl. H04B 5/00; H04B 1/3888

(52) U.S. Cl. CPC H04B 5/0031; H04B 1/3888; H04W 88/04

(57) ABSTRACT

A mobile device dock arrangement includes a mobile device dock and a near field communication (NFC) device. The NFC device includes a first NFC antenna for obtaining data from a readable object when the NFC device is operatively coupled to the NFC reader, where the first NFC antenna permits positioning the first NFC antenna remote from the mobile device dock and the mobile device for obtaining the data from the readable object at a position remote from the mobile device dock and the mobile device; a second NFC antenna coupleable to the mobile device dock and configured, when coupled to the mobile device dock, for presenting the data in readable form to the NFC reader of the mobile device; and a cord coupled, or coupleable, to the first NFC antenna and the second NFC antenna for carrying the data from the first NFC antenna to the second NFC antenna.

### FIELD

The present invention is directed to remote repeater device for a mobile device dock. The present invention is also directed to cases for a mobile device dock that includes a remote repeater device and methods of making and using.

### BACKGROUND

Mobile devices, such as smartphones, cellular or mobile phones, tablets, personal data assistants, and other portable devices, are now ubiquitous. A mobile device can include a reader, such as a NFC (near field communications) reader, for reading tags or other readable objects on or in a product or other item. In at least some circumstances, access to the reader of the mobile device may be limited or inconvenient. For example, a mobile device may be mounted in a vehicle and the reader may be difficult or inconvenient to access because of the mounting position.

### BRIEF SUMMARY

One embodiment is a mobile device dock arrangement that includes a mobile device dock configured for coupling to a mobile device with a NFC reader and a near field communication (NFC) device. The NFC device includes a first NFC antenna configured for obtaining data from the readable object when the NFC device is operatively coupled to the NFC reader, wherein the first NFC antenna is configured to permit positioning the first NFC antenna remote from the mobile device dock and the mobile device for obtaining the data from the readable object at a position remote from the mobile device dock and the mobile device; a second NFC antenna coupleable to the mobile device dock and configured, when coupled to the mobile device dock, for presenting the data in readable form to the NFC reader of the mobile device coupled to the mobile device dock; and a cord coupled, or coupleable, to the first NFC antenna and the second NFC antenna and configured for carrying the data from the first NFC antenna to the second NFC antenna.

In at least some embodiments, the mobile device dock arrangement further includes a mount simultaneously coupleable to the mobile device dock and the first NFC antenna. In at least some embodiments, the first NFC antenna includes a first housing and the first housing includes holes configured for attachment of the mount to the first NFC antenna.

In at least some embodiments, the mobile device dock arrangement further includes the mobile device. In at least some embodiments, the mobile device includes the NFC reader. In at least some embodiments, the mobile device dock arrangement further includes the NFC reader as an accessory coupled, or coupleable, to the mobile device.

In at least some embodiments, the second NFC antenna includes a second housing and the second housing includes holes configured for mounting of the second NFC antenna to the mobile device dock. In at least some embodiments, the second NFC antenna is mounted on the mobile device dock.

In at least some embodiments, the mobile device dock includes the second NFC antenna as a permanent part of the mobile device dock. In at least some embodiments, the cord is hardwired to the first NFC antenna. In at least some embodiments, the cord is hardwired to the second NFC antenna. In at least some embodiments, the cord includes a first connector and the first NFC antenna includes a second connector configured to removably couple to the first connector. In at least some embodiments, the cord includes a third connector and the second NFC antenna includes a fourth connector configured to removably couple to the third connector.

Another embodiment is a near field communication (NFC) repeater device configured for coupling to a mobile device dock for a mobile device with an NFC reader. The NFC repeater device includes a first NFC antenna configured for obtaining data from a readable object when the NFC device is operatively coupled to the NFC reader, wherein the first NFC antenna is configured to permit positioning the first NFC antenna remote from the mobile device dock and the mobile device for obtaining the data from the readable object at a position remote from the mobile device dock and the mobile device; a second NFC antenna coupleable to the mobile device dock and configured, when coupled to the mobile device dock, for presenting the data in readable form to the NFC reader of the mobile device; and a cord coupled, or coupleable, to the first NFC antenna and the second NFC antenna and configured for carrying the data from the first NFC antenna to the second NFC antenna.

In at least some embodiments, the cord is hardwired to the first NFC antenna. In at least some embodiments, the cord is hardwired to the second NFC antenna. In at least some embodiments, the cord includes a first connector and the first NFC antenna includes a second connector configured to removably couple to the first connector. In at least some embodiments, the cord includes a third connector and the second NFC antenna includes a fourth connector configured to removably couple to the third connector.

In at least some embodiments, the first NFC antenna includes a first housing and the first housing includes holes configured for attachment of a mount to the first NFC antenna. In at least some embodiments, the second NFC antenna includes a second housing and the repeater housing includes holes configured for mounting of the second NFC antenna to a mobile device dock.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic perspective front view of one embodiment of mobile device dock arrangement with a mobile device dock, a NFC device with two NFC antennas, and a mobile device, according to the invention;

FIG. 1B is a schematic perspective back view of the mobile device dock arrangement of FIG. 1A, according to the invention;

FIG. 2A is a schematic perspective top view of one embodiment of a NFC device with two NFC antennas, according to the invention;

FIG. 2B is a schematic perspective top view of the NFC device of FIG. 2A with a portion of the housing of the first NFC antenna removed, according to the invention;

FIG. 2C is a schematic perspective partial cross-sectional view of the NFC device of FIG. 2A, according to the invention;

FIG. 2D is a schematic perspective top view of the NFC device of FIG. 2A with the housing of the first NFC antenna removed, according to the invention; and

FIG. 3 is a schematic top view of another embodiment of a NFC device with connectors on the first NFC antenna, cord, and second NFC antenna, according to the invention.

### DETAILED DESCRIPTION

The present invention is directed to remote repeater device for a mobile device dock. The present invention is also directed to cases for a mobile device dock that includes a remote repeater device and methods of making and using.

Mobile devices are used in a variety of contexts for interactions with multiple users. For example, a mobile device can be used in a delivery vehicle for managing the deliveries. Similarly, mobile devices can be used as point-of-sale devices to complete transactions with a customer. The mobile device can include a reader, such as a NFC (near field communications) reader, for reading tags on or in a product or other item. In at least some circumstances, it may be difficult or inconvenient to access the mobile device for reading a tag or other readable object. A device remote from the mobile device which can assist in reading NFC tags or other readable objects can be provide more flexibility in reading the NFC tags or other readable objects.

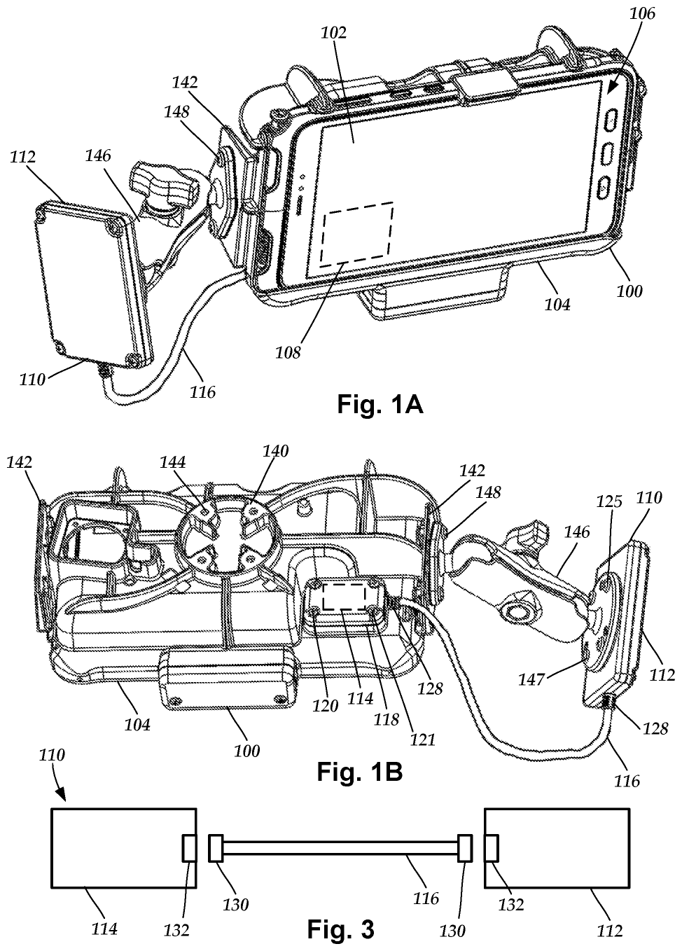

FIGS. 1A and 1B illustrate one embodiment of a mobile device dock 100 for a mobile device 102, such as a cellular or mobile phone, a smartphone, a tablet, a personal data assistant, a laptop (or other computer), or any other suitable mobile device. The mobile device dock 100 includes a shell 104 for the mobile device which defines a cavity 106 to receive the mobile device 102. The shell 104 may completely or partially surround a perimeter of the mobile device 102. Examples of mobile device docks 100 (or accessory attachments that can be used as a mobile device dock) can be found at U.S. Pat. Nos. 11,029,731; 11,076,032; and 11,277,506; U.S. Patent Application Publications Nos. 2021/0194256 and 2021/0391678; and U.S. patent application Ser. Nos. 17/174,152; 17/246,003; and Ser. No. 17/397,258, all of which are incorporated herein by reference in their entireties.

In at least some embodiments, the mobile device dock 100 includes a back mounting site 140 or one or more side mounting sites 142 or any combination thereof, as illustrated in FIG. 1B. The back mounting site 140 or side mounting site(s) 142 include holes 144 for receiving fasteners 148 for fastening a mount 146, as illustrated in FIGS. 1A and 1B. Any suitable mount 146 can be used. Non-limiting examples of mounts, mounting arrangements, and mounting devices can be found at, for example, U.S. Pat. Nos. 5,845,885; 6,561,476; 7,320,50; 7,997,554; 8,454,178; 8,505,861; 9,831,904; RE42,060; RE42,581; and RE43,806 and U.S. patent application Ser. Nos. 16/298,952 and 17/174,152, all of which are incorporated herein by reference in their entireties.

The mobile device 102 includes a near field communication (NFC) reader 108. For example, many mobile devices 102 used in retail or other commercial settings are equipped with a NFC reader 108. A mobile device 102 can have a NFC reader 108 as a permanent part of the mobile device or as an accessory attached, or otherwise coupled, to the mobile device.

Attached to the mobile device dock 100 (or incorporated as part of the mobile device dock) is a near field communication (NFC) device 110, such as an NFC repeater device, that includes a first NFC antenna 112, a second NFC antenna 114 (FIG. 1B), and a cord 116 connecting the first NFC antenna to the second NFC antenna. The first NFC antenna 112 can be positioned remote from the mobile device dock 100 to facilitate access for reading a NFC tag or other readable object on or within an item.

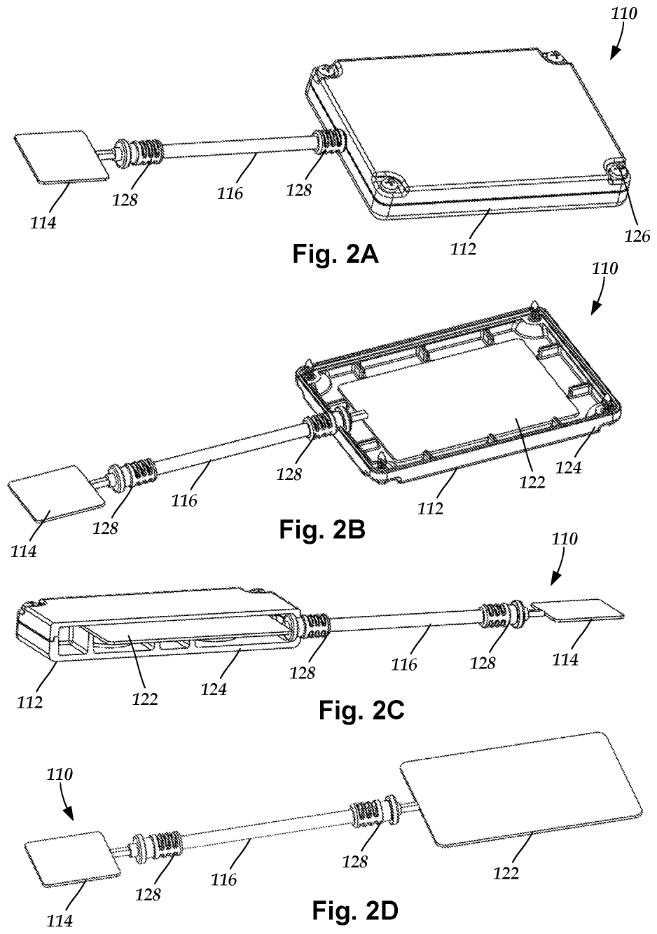

FIGS. 2A to 2D illustrate one embodiment of the NFC device 110 uncoupled from the mobile device dock 100. The first NFC antenna 112 receive data from a readable object, such as a NFC tag, on a product or other item to obtain data from the readable object. The second NFC antenna 114 receives the data via the cord 116 and presents the data in readable form to the NFC reader 108 of the mobile device 102.

In at least some embodiments, the NFC reader 108 inductively couples to the second NFC antenna 114 to provide power to the first and second NFC antennas 112, 114. This results in the first NFC antenna producing an electromagnetic field for interaction with an NFC tag or other readable object resulting in the first NFC antenna receiving data from the NFC tag or other readable object. In at least some embodiments, the first NFC antenna 112 can be part of a NFC reader that obtains the data and delivers the data to the second NFC antenna 114 for transmission to the NFC reader 108 of the mobile device 102.

In at least some embodiments, the first NFC antenna 112 includes a first antenna arrangement 122 disposed in a first housing 124. In at least some embodiments, the first housing 124 is a two-part shell with fasteners 126. In at least some embodiments, the first housing 124 includes holes 125 for attachment of a mount 146 using fasteners 147, as illustrated in FIG. 1B.

The first NFC antenna 112 can be tethered to the mobile device dock 100 using the cord 116 and the second NFC antenna 114. The first NFC antenna 112 can be positioned remote (for example, a distance of at least 5, 10, or more centimeters away) from the mobile device dock. For example, remote positioning may facilitate capture of data from a NFC tag or other readable object that may be difficult or inconvenient to capture using the mobile device 102 in the mobile device dock 100. In at least some embodiments, the first NFC antenna 112 can be attached to a mount 146 that is attached to the mobile device dock 100, as illustrated in FIGS. 1A and 1B. In other embodiments, the first NFC antenna 112 is attached to a mount 146 that is attached to another surface, device, or the like. In yet other embodiments, the first NFC antenna 112 is not attached to a mount and is movable from position to position without detachment from a mount, surface, or other device.

In at least some embodiments, the second NFC antenna 114 is disposed in a second housing 118 that can be attached to the mobile device dock 100 using fasteners 120 through holes 121 in the second housing, as illustrated in FIG. 1B. In at least some other embodiments, the second NFC antenna 114 is a permanent or integrated part of the mobile device dock 100 instead of an arrangement that can be readily coupled to, or uncoupled from, the mobile device dock.

The cord 116 includes conductors, such as wires or traces, that carry the data from the first NFC antenna 112 to the second NFC antenna 114. The cord 116 extends from the first NFC antenna 112 to the second NFC antenna 114 and preferably includes one or more strain relief elements 128 where the cord exits the first NFC antenna or the second NFC antenna or their respective housings 124, 118. Any suitable strain relief element 128 can be used including, for example, the baffle-type strain relief in the illustrated embodiment. The cord 116 includes a jacket encasing wires or traces that extend along the cord 116.

In at least some embodiments, the cord 116 is hardwired to the antenna arrangement 122 of the first NFC antenna 112 or to the second NFC antenna 114 or to both, as illustrated in FIGS. 2A to 2D. In at least some embodiments, as illustrated in FIG. 3, one or both of the ends of the cord 116 have a connector 130 such as, for example, any type of USB connector (for example, any type of USB-A, USB-B, USB-C, Micro-USB, or Mini-USB connector), Lightning connector, prong connector, audio- or video-type connector, connector for a vehicle cigarette lighter, or the like. The cord 116 can then connect to a corresponding connector 132 of the first NFC antenna 112 or the second NFC antenna 114 or both.

The above specification provides a description of the manufacture and use of the invention. Since many embodiments of the invention can be made without departing from the spirit and scope of the invention, the invention also resides in the claims hereinafter appended.

1. A mobile device dock arrangement, comprising:
a mobile device dock configured for coupling to a mobile device with a NFC reader, the mobile device dock comprising a shell defining a cavity to receive the mobile device, wherein the shell is configured to completely surround a perimeter of the mobile device; and
a near field communication (NFC) device comprising:
a first NFC antenna configured for obtaining data from a readable object when the NFC device is operatively coupled to the NFC reader, wherein the first NFC antenna is configured to permit positioning the first NFC antenna remote from the mobile device dock and the mobile device for obtaining the data from the readable object at a position remote from the mobile device dock and the mobile device;
a second NFC antenna coupleable to the mobile device dock and configured, when coupled to the mobile device dock, for presenting the data in readable form to the NFC reader of the mobile device coupled to the mobile device dock; and
a cord coupled, or coupleable, to the first NFC antenna and the second NFC antenna and configured for carrying the data from the first NFC antenna to the second NFC antenna.

2. The mobile device dock arrangement of claim 1, further comprising a mount simultaneously coupleable to the mobile device dock and the first NFC antenna.

3. The mobile device dock arrangement of claim 2, wherein the first NFC antenna comprises a first housing and the first housing comprises holes configured for attachment of the mount to the first NFC antenna.

4. The mobile device dock arrangement of claim 1, further comprising the mobile device.

5. The mobile device dock arrangement of claim 4, wherein the mobile device comprises the NFC reader.

6. The mobile device dock arrangement of claim 4, further comprising the NFC reader as an accessory coupled, or coupleable, to the mobile device.

7. The mobile device dock arrangement of claim 1, wherein the second NFC antenna comprises a second housing and the second housing comprises holes configured for mounting of the second NFC antenna to the mobile device dock.

8. The mobile device dock arrangement of claim 7, wherein the second NFC antenna is mounted on the mobile device dock.

9. The mobile device dock arrangement of claim 1, wherein the mobile device dock comprises the second NFC antenna as a permanent part of the mobile device dock.

10. The mobile device dock arrangement of claim 1, wherein the cord is hardwired to the first NFC antenna.

11. The mobile device dock arrangement of claim 1, wherein the cord is hardwired to the second NFC antenna.

12. The mobile device dock arrangement of claim 1, wherein the cord comprises a first connector and the first NFC antenna comprises a second connector configured to removably couple to the first connector.

13. The mobile device dock arrangement of claim 12, wherein the cord comprises a third connector and the second NFC antenna comprises a fourth connector configured to removably couple to the third connector.

14. A near field communication (NFC) repeater device configured for coupling to a mobile device dock for a mobile device with an NFC reader, the NFC repeater device comprising:
a first NFC antenna configured for obtaining data from a readable object when the NFC device is operatively coupled to the NFC reader, wherein the first NFC antenna is configured to permit positioning the first NFC antenna remote from the mobile device dock and the mobile device for obtaining the data from the readable object at a position remote from the mobile device dock and the mobile device;
a second NFC antenna coupleable to the mobile device dock and configured, when coupled to the mobile device dock, for presenting the data in readable form to the NFC reader of the mobile device; and
a cord coupled, or coupleable, to the first NFC antenna and the second NFC antenna and configured for carrying the data from the first NFC antenna to the second NFC antenna, wherein the cord comprises at least one strain relief element.

15. The NFC repeater device of claim 14, wherein the cord is hardwired to the first NFC antenna.

16. The NFC repeater device of claim 14, wherein the cord is hardwired to the second NFC antenna.

17. The NFC repeater device of claim 14, wherein the cord comprises a first connector and the first NFC antenna comprises a second connector configured to removably couple to the first connector.

18. The NFC repeater device of claim 17, wherein the cord comprises a third connector and the second NFC antenna comprises a fourth connector configured to removably couple to the third connector.

19. The NFC repeater device of claim 14, wherein the first NFC antenna comprises a first housing and the first housing comprises holes configured for attachment of a mount to the first NFC antenna.

20. The NFC repeater device of claim 14, wherein the second NFC antenna comprises a second housing and the repeater housing comprises holes configured for mounting of the second NFC antenna to a mobile device dock.
